(19) United States
(12) Patent Application Publication
(10) Pub. No.: US 2008/0105620 A1
(43) Pub. Date: May 8, 2008

(54) Water purification system

(76) Inventor: Lawrence A. Hicks, Lincolnshire, IL (US)

Correspondence Address: SCHIFF HARDIN, LLP;PATENT DEPARTMENT, 6600 SEARS TOWER, CHICAGO, IL, 60606-6473, US

(21) Appl. No.: 11/593,867

(22) Filed: Nov. 6, 2006

(51) Int. Cl. C02F 1/42

(52) U.S. Cl. 210/681; 210/284

(57) ABSTRACT

A water purification system and method for the use and maintenance service of said system, whereby a combination of a primary ion exchange resin element, a secondary ion exchange resin element, a water quality monitor placed so as to indicate that the primary resin element is exhausted and the secondary resin element is being used, activated carbon elements, sterilizing or sanitizing filters, and sanitizing components such as UV radiation, or other sanitizing technologies, is used to produce purified water for consumption or other intended use. Both the primary and secondary ion exchange resin elements are comprised of one or more mixed bed ion exchange resin unit(s), or one or more paired set(s) of anion and cation exchange resin units arranged in series. The system's redundant ion exchange resin configuration allows purification to continue after the resin in the primary resin element is exhausted and can no longer remove unwanted impurities in the water. A monitor is used to detect when maintenance service of the primary resin element is required. The redundant or secondary resin element continues to remove impurities from the water, allowing the user and/or maintenance service provider flexibility and tractability in scheduling system maintenance without significant interruption of on-line supply of purified water.

### BACKGROUND OF THE INVENTION

1. Field of the Invention

The present invention relates generally to a water purification system and more specifically to a point of use water purification system with redundant primary and secondary ion exchange resin elements.

2. Description of the Related Art

Ground and surface waters, including but not limited to, aquifers, springs, lakes, reservoirs, rivers, canals, and the like provide source water for public and private water supplies. This source water is often treated to specified potable levels by state, municipal, and/or other public authorities prior to distribution to the public for consumptive, commercial, and/or industrial use. Regulations limit the level of contaminants allowed in water that is distributed to the public, and public water treatment is intended to reduce the level of contamination in the water supply to the levels required by law and other regulations. However, the safety of the level of contaminants allowed to remain in such water per the regulations has been questioned in numerous scientific studies and by significant numbers of public users of municipal water supplies. An additional problem presented by public water supply systems is that new contaminants may be introduced through municipal delivery systems downstream from the treatment facility. Further, well water drawn from ground waters is often contaminated with substances which make it unsuitable for consumption or other uses.

The contaminants found in public or private water supplies can make such water potentially or actually harmful and/or aesthetically unpleasant and undesirable for consumption and/or use in rinsing, preparing, and cooking edible food and drink. Additionally, these waters may not be sufficiently pure for certain industrial and/or commercial applications. All of these factors make additional purification of water at the point of use desirable, and sometimes necessary, to supply water of the required quality for its intended use.

A variety of technologies are available to remove different contaminants from water. The different technologies commonly used in commercial, industrial, and residential water purification systems include, but are not limited to, reverse osmosis, ion exchange resins, activated carbon filters, ozone treatment, ultraviolet (UV) radiation, and physical filtration. UV radiation is commonly used to sanitize water by killing microorganisms and leaves no additional residue in the water. Other available sanitation methods, such as the addition of oxidizing agents such as halogens or ozone, may leave residue in the water that is undesirable. In addition to the above technologies intended to destroy microorganisms, technology for removing microorganisms from water may incorporate the use of sterilizing filters. A 0.22 or 0.45 micron sterilizing filter is capable of reliably removing both viable and destroyed microorganisms. Pharmaceutical grade sterilizing filters provide an added benefit of being constructed of materials that produce very low levels of extractables (contaminants that may be introduced into the water by some filter materials). Often, a 1 micron or similar prefilter is used before, or upstream from, a sterilizing filter to prevent clogging of the sterilizing filter and enhance overall throughput performance.

Soluble contaminants in water are removed through chemical manipulation of the water. Activated carbon with sufficient surface area adsorbs most soluble organic compounds including those which may be harmful when consumed repeatedly even at low concentrations. Activated carbon can also remove soluble toxic heavy metal compounds and any soluble organic carbon compounds released into the water by upstream ion exchange resin treatment.

Soluble inorganic salts and some soluble heavy metal compounds that may be found in municipal and well water can be removed by ion exchange resins, along with virtually all of the residual chlorine related sanitizing compounds found in municipal water distribution systems. Mixed bed ion exchange resins contain both anion and cation exchange resins to remove both positively and negatively charged ions with a single resin bed. Ion exchange technology may be also be used in the form of separate paired sets of anion and cation exchange resin units.

As these, and other, different purification technologies and methods remove different types of contaminants, various combinations of such purification technologies and methods are often employed at the point of use in commercial, industrial, and residential water purification systems to achieve the desired purification for the intended use. For example, U.S. Pat. No. 6,080,313, incorporated herein by reference, describes a system using a flowboard to connect cascading ion exchange resin units, filter cartridges, ultraviolet radiation, and activated carbon to produce purified water. Reverse osmosis, as well as filtration, activated carbon adsorption, ultraviolet light treatment, and ion exchange resin have been combined in a counter top water purification system as disclosed in U.S. Pat. No. 6,099,735, incorporated herein by reference. U.S. Pat. Nos. 4,474,620 and 4,876,014, incorporated herein by reference, also use combinations of the previously listed elements to produce purified water. However, one of the unmet challenges in providing end users with continuous on-demand point-of-use purified water is maintaining operation and performance of the purification system to specification without significant operational downtime, and/or costly, inefficient, and/or ill timed demand for maintenance service.

While previously available water purification systems have used different combinations of purification technologies to produce purified water, the problem of continuous on-demand operation without significant maintenance service interruption has not been adequately addressed. Systems that use ion exchange resin to make purified water available on-demand will not perform to specification once the ion exchange resin has been exhausted. Such exhaustion may be reliably detected with the use of conductance or resistance monitors. However, upon monitor detection of exhausted ion exchange resin capability, the purification system will no longer perform to specification until maintenance service is performed. Monitors of water quality have been previously implemented in some water purification systems. Such systems are described in U.S. Pat. Nos. 5,698,395, 5,110,479, and 6,080,313, each of which is incorporated herein by reference.

### SUMMARY OF THE INVENTION

The present invention provides an on-demand water purification system capable of supplying purified water at the point of use for residential, commercial, and/or industrial purposes without requiring a significant interruption in operation to schedule and perform maintenance service on the system. In one aspect of the invention, a primary ion exchange resin element is followed by a secondary ion exchange resin element configured or arranged in series to permit the system to continue to provide ion exchange capacity to specification after the primary resin element is exhausted. Primary and secondary ion exchange resin elements used in the invention may be one or more mixed bed ion exchange resin units, and/or one or more paired sets of anion exchange and cation exchange resin units.

In another aspect, the water quality is monitored at the output of the primary ion exchange resin element, to determine when said primary resin element is exhausted and requires maintenance service. The need for maintenance of said primary ion exchange resin element is communicated to the user, the maintenance service provider, or both. The notice to the user and/or maintenance service provider is triggered or initiated by a water quality monitor placed after, or downstream from, said primary ion exchange resin element, and before, or upstream from, the secondary ion exchange resin element. The type of notice given can take different forms, depending on the needs of the user and maintenance service provider. When said primary ion exchange resin element is exhausted, said secondary ion exchange resin element will continue to purify the water, allowing the system to continue to perform and function to system specifications while maintenance is initiated and scheduled.

An advantage of the present invention is that it provides an on-demand supply of purified water without significant service interruption. Upon notice that the primary ion exchange resin element is exhausted, arrangements for maintenance service are then made at the convenience of both the maintenance service provider and the system user while the system continues to perform to specifications. Thus, the system continues to operate to specifications during the period of time necessary to bring maintenance materials and personnel to the system site. Convenient and cost efficient implementation of maintenance service involves the removal of the exhausted primary ion exchange resin element, replacement of said primary ion exchange resin element with the secondary ion exchange resin element, and the incorporation of a fresh or regenerated replacement ion exchange resin element as the successor secondary ion exchange resin element. This may be done either by the physical repositioning of said elements, or by rearrangement of the transfer lines which carry water to and from the primary and secondary ion exchange resin elements. Any other required maintenance service of the system, such as, but not limited to, sanitization of part or all of the system, UV bulb replacement, prefilter replacement, carbon unit replacement, and sterilizing filter replacement may be conducted at the same time.

Other objects, features, and advantages of the present invention will become apparent from the following detailed description. It should be understood, however, that the detailed description and the specific examples, while indicating embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by referring to one or more of these drawings in combination with the detailed description of specific embodiments presented herein:

FIG. 1 is diagram of the component parts of the preferred embodiment of the invention, illustrating one possible configuration of separate primary and secondary ion exchange resin elements configured in series, and a system monitor placed after, or downstream from, the primary ion exchange resin element, and before, or upstream from, the secondary ion exchange resin element.

FIG. 2 is a diagram of one portion of an alternative embodiment of the invention, illustrating another possible configuration of separate primary and secondary ion exchange resin elements configured in series, each element consisting of one or more paired sets of anion exchange and cation exchange resin units, and a system monitor placed after, or downstream from, the primary ion exchange resin element, and before, or upstream from, the secondary ion exchange resin element.

FIG. 3 is a diagram of one portion of an additional alternative embodiment of the invention, illustrating another possible configuration of separate primary and secondary ion exchange resin elements configured in parallel, each element consisting of one or more paired sets of anion exchange and cation exchange resin units, and a system monitor controlling a flow direction valve supplying water to either the primary ion exchange resin element or the secondary ion exchange resin element.

### DETAILED DESCRIPTION OF THE PREFERRED EMBODIMENT OF THE INVENTION

In describing the water purification system, the word “element” will be used to describe a component of the system. The word “unit” will be used to describe part of an element of the water purification system. Thus, an element may be comprised of more than one unit where desired or necessary. In one embodiment of the invention, each element has one inlet and one outlet, regardless of the configuration of the units within each such element.

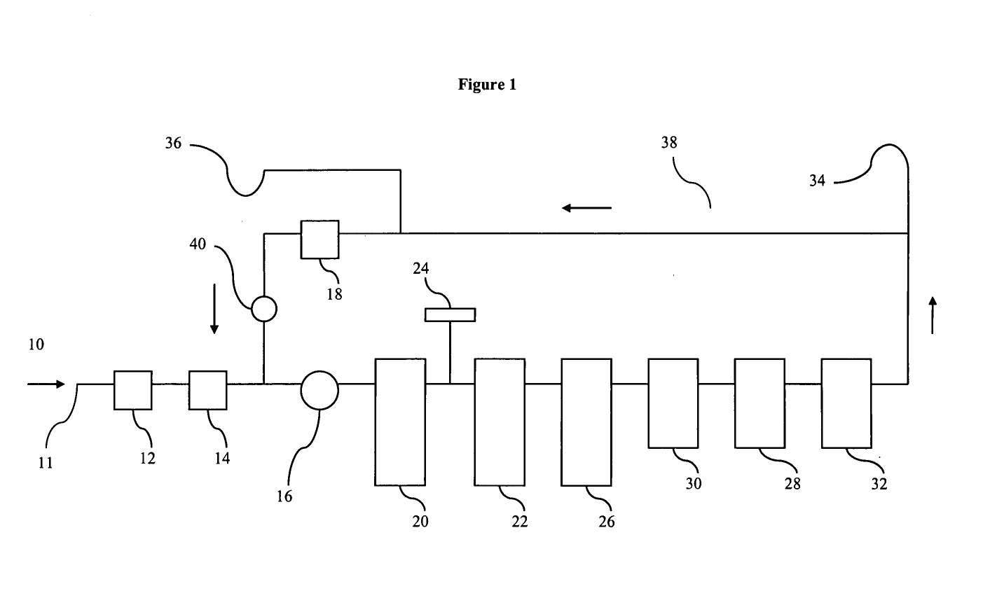

Referring to FIG. 1, the water purification system 10 is fed municipally supplied or well water at system inlet 11. The water temperature and pressure must not exceed the standard operating range limits for any ion exchange resin element or any other component in use in the system, or otherwise compromise the system integrity.

Preferably, water flows in a recirculation loop 38 through the system 10 to minimize the growth of microorganisms throughout said system 10. The outlets 34 and 36, and any additional outlets placed between the sterilizing filter 32 and the check valve 18, may lead to an ice maker, faucet, or any other outlet device that will be dispensing purified water. Purified water is drawn out of any such system outlet of the recirculating loop 38 as needed. The pump 16 in the water purification system 10 provides the force that keeps the water flowing through the system loop 38, and the check valve 18 maintains flow in the proper direction and prevents unpurified water from bypassing the system on demand for water at any outlet.

In the embodiment shown in FIG. 1, the water is purified by ion exchange resin element 20. A monitor 24 is placed between the primary and secondary ion exchange resin elements 20 and 22 to detect changes in the water quality that indicate when the primary ion exchange resin element 20 is exhausted. Upon notice from the monitor that the primary ion exchange resin element 20 is exhausted and requires maintenance, a signal or notice of maintenance requirement is initiated. Until maintenance is performed, the secondary ion exchange resin element 22 continues to purify water passing through the system, water quality remains unchanged, and system operation to specification continues unabated. If maintenance service is not eventually performed, system operation to specification continues only until the secondary ion exchange resin element 22 is exhausted.

The signal or notice from the monitor 24 may be sent via a variety of means, including, but not limited to, a change in the visual appearance of a display of the monitor 24, an audio alert, a telephone and/or radio signal sent directly or indirectly to the maintenance service provider, and/or any other type of signal that would alert the user and/or the maintenance service provider of the need for maintenance, or any combination of such signals that would accomplish the same goal. Depending on the capacity of the primary ion exchange resin element and the volume of water previously purified by said primary ion exchange resin element, the ion exchange resin elements 20 and/or 22 remove soluble inorganic compounds, including soluble heavy metal compounds, and chlorine related sanitizing compounds from the water. When ion exchange resins remove such soluble compounds, the electrical conductivity of the water significantly decreases. The monitor 24 measures the conductivity of the water exiting said primary ion exchange resin element 20. When said primary ion exchange resin element 20 can no longer remove such compounds in the water, it is exhausted, the conductivity of the water exiting said element 20 increases, and the monitor 24 sends a signal to indicate that the system requires maintenance service.

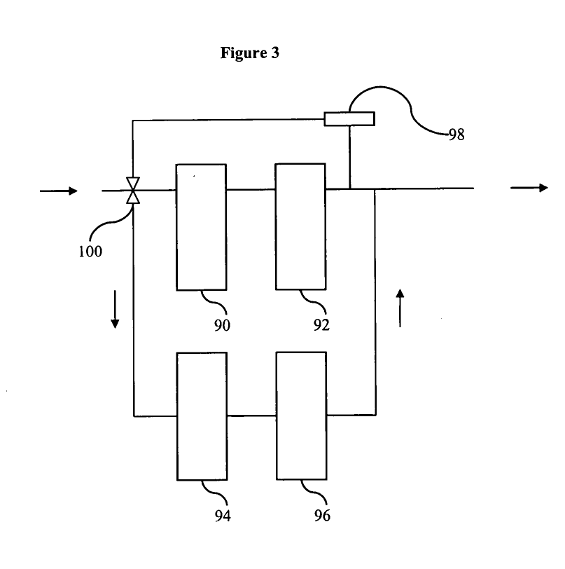

The water purification system 10 is designed to allow said system 10 to continue to function after the resin in the primary ion exchange resin element 20 is exhausted. The water will pass through such primary ion exchange resin element 20 without reacting when the resin is exhausted, but the secondary ion exchange resin element 22 will continue to remove the same impurities from the water as did the primary ion exchange resin element 20 until the water purification system 10 can be subjected to maintenance service procedures, or if not so maintained, until the secondary ion exchange resin element 22 is eventually exhausted. The monitor 24 preferably does not shut down the system 10, but only initiates and provides notice of the need for maintenance. An additional monitor may be placed directly after, or downstream from, the secondary ion exchange resin element 22 to provide notice of system failure and/or to shut down the system if maintenance is not provided in a timely way. When parallel configurations are used, as in FIG. 3, the monitor 24 triggers valves and/or other devices to change the flow path of the water in the system.

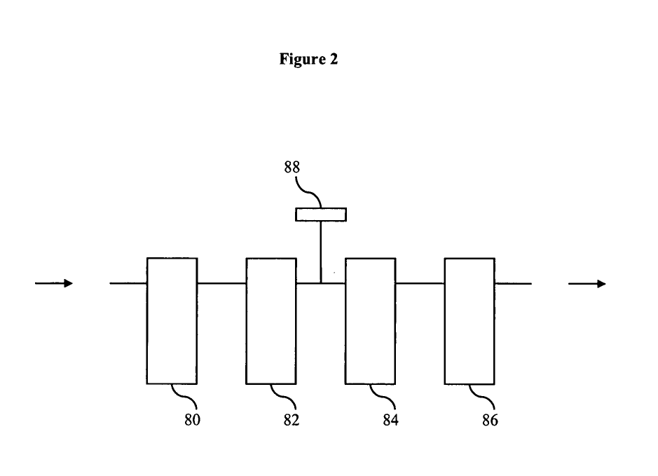

While the water purification system 10 in FIG. 1 may be seen as single mixed bed units as primary and secondary ion exchange resin elements 20 and 22 in series, it could also be configured in a variety of other ways. Either or both primary and secondary ion exchange resin elements may be composed of one or more mixed bed ion exchange resin units, or one or more paired sets of anion and cation exchange units. Other possible configurations are illustrated in FIGS. 2 and 3, and are discussed below, but the invention is not limited to the embodiments detailed herein.

In FIG. 1, the primary and/or secondary ion exchange resin elements 20 and 22 may take the form of interchangeable mixed bed ion exchange resin units. In the preferred embodiment of the invention, maintenance service is performed after the monitor 24 indicates that the primary mixed bed ion exchange resin element 20 is exhausted. During maintenance service, the secondary mixed bed ion exchange resin element 22 is used to replace the primary mixed bed ion exchange resin element 20, and a successor ion exchange resin element, whether fresh, regenerated, or new, is installed in the system as the secondary ion exchange resin element 22. Thus, ion exchange resin is never wasted, and the supply of purified water that meets specifications continues unabated, from the time maintenance service is initiated by action of the monitor until such maintenance is implemented, except for the unprecedented short time taken to switch and replace elements.

In one embodiment, after the water passes through the primary and secondary ion exchange resin elements 20 and 22, in the water purification system 10 shown in FIG. 1, or any of the possible alternatives, the water is then preferably sent through activated carbon element 26 arranged in a series configuration with the ion exchange resin elements. The activated carbon element 26 removes soluble nonionic organic and additional heavy metals compounds from the water through adsorption. The activated carbon element 26 may also be placed before, or upstream from, the primary and secondary ion exchange resin elements 20 and 22. In that configuration, the activated carbon element 26, instead of the primary and secondary ion exchange resin elements 20 and 22, removes chlorine related sanitizing compounds from the water, as well as soluble nonionic organic and heavy metal compounds. It is preferable, however, to place the activated carbon element 26 after, or downstream from, the primary and secondary ion exchange resin elements 20 and 22, which would allow for any soluble nonionic organic compounds introduced and released into the water by the primary and secondary ion exchange resin elements 20 and 22 to be removed by the subsequent activated carbon element 26, in addition to allowing the activated carbon element 26 to better perform its function of the removal of soluble nonionic organic and heavy metal compounds contaminating the input water by avoiding the use of activated carbon to remove chlorine related compounds.

A secondary activated carbon element, not shown in FIG. 1, may be used in the system to provide removal of soluble nonionic organic and heavy metal compounds after the primary activated carbon element has been exhausted. A secondary activated carbon element will provide additional nonionic compound removal capacity in the system. The incorporation of a secondary activated carbon element which, upon maintenance service, is to be configured and placed as the primary activated carbon element, with a successor fresh activated carbon element placed as the secondary activated carbon element, is included in this embodiment of the invention. A monitor capable of monitoring the performance of the primary activated carbon element may be placed, but is not required, between the primary and secondary activated carbon elements to detect when the primary activated carbon element is exhausted and send a signal or other notice to the user and/or the maintenance service provider when replacement of the primary activated carbon element is appropriate. The primary and secondary activated carbon elements may be placed in series, in parallel, or in any other configuration that allows for the secondary activated carbon element to provide additional nonionic compound removal capacity in the water purification system.

The remaining components of the water purification system 10 serve to sanitize the water and maintain proper flow in the loop. A sanitizing element such as, but not limited to, UV radiation element 28 is used to kill or inactivate most, if not all, of the microbes present in the water. The water in the system 10 is preferably recirculated to reduce the growth of microbes; however, most microbes circulating in the system will be substantially destroyed by the sanitizing element. While UV radiation, ozone, or other technology lethal to microbial viability may be used, FIG. 1 illustrates a system 10 using UV radiation element 28.

A prefilter element 30 is preferably placed before the UV radiation element 28. This prefilter element 30 can also be located after the UV radiation element 28, so long as it is placed upstream from and in series with the sterilizing filter element 32. The prefilter element 30 is preferably 1 micron in effective pore size, but may take the form of any prefilter that will work with the system requirements. The sterilizing filter element 32 is preferably a sterilizing pharmaceutical grade filter, most preferably of 0.22 or 0.45 micron pore size, capable of reliably removing microorganisms from the water. The function of the prefilter element 30 placed upstream from the sterilizing filter element 32 is to prevent said sterilizing filter element 32 from becoming prematurely clogged and significantly slowing the delivery rate of water to the recirculation loop 38 and outputs 34 and 36. The sterilizing filter element 32 is preferably the final element before any outlets where water is drawn out of the water purification system. The sterilizing filter element 32 may be placed in other locations, but optimal microbial water quality is achieved when the sterilizing filter element 32 is the final element that the water passes through before delivery to outlets such as 34 and 36. Additional sterilizing filters may be incorporated in any or all output deadlegs which are not part of the recirculating loop 38.

The combination of the primary and secondary ion exchange resin elements 20 and 22, the monitor 24 configured to indicate exhaustion of the primary ion exchange resin element, sanitizing component element 28, prefilter element 30, sterilizing filter element 32, recirculating pump element 16, check valve element 18, and activated carbon element 26 with or without primary and secondary configuration, and with or without monitoring of the primary activated carbon element, work to produce water that is both aesthetically pleasing and contains hazardous impurities, contaminants, and microorganisms at levels many orders of magnitude lower than the input municipal or well water.

The water in the water purification system 10 is preferably constantly recirculated through the system 10. A closed loop 38 is formed with an inlet 11 where the water enters the system 10 through a valve 12 and a water meter 14, and exits at one or more outlets 34 and 36. The embodiment illustrated in FIG. 1 has two outlets 34 and 36 for the water purification system 10, providing purified water to a faucet 34 and to an ice maker 36. A circulation direction flow indicator element 40 may be included in the system 10 to provide visual or other assurance that water is flowing in the correct and proper direction through the system 10. The word continuous may be used to describe both the configuration of the water purification system itself and the constant flow of the water into and through the system.

FIG. 2 illustrates an alternate embodiment where two paired sets of anion and cation exchange resin units are arranged in series. Anion exchange resin unit 80 and cation exchange resin unit 82 comprise the primary ion exchange resin element, and anion exchange resin unit 84 and cation exchange resin unit 86 comprise the secondary ion exchange resin element. A configuration with the anion and cation exchange resin units reversed in position would also accomplish the same desired purification. The monitor 88 is placed after, or downstream from, the primary ion exchange resin element comprised of the paired set of anion and cation exchange resin units 80 and 82, and before, or upstream from, the secondary ion exchange resin element comprised of the paired set of anion and cation exchange resin units 84 and 86. This configuration does not permit detection of which individual anion or cation exchange resin unit is exhausted, but does provide notice when either of the first two units 80 and 82 comprising the primary ion exchange resin element is so exhausted. The secondary ion exchange resin element allows the water purification system to continue to function to specification until maintenance service is performed or until said secondary ion exchange resin element is exhausted. While FIG. 2 shows a single paired set of anion and cation exchange resin units as the primary ion exchange resin element and a single paired set of anion and cation exchange resin units as the secondary ion exchange resin element, the system may alternatively be configured with multiple paired sets of anion and cation exchange resin units as either or both primary and secondary ion exchange resin elements.

Alternatively, as shown in FIG. 3, the primary and secondary ion exchange resin elements may be configured in parallel, with a monitor designed to trigger redirection of the flow of water to the secondary ion exchange resin element, comprised of one or more paired sets of anion and cation exchange resin units 94 and 96, when the primary resin element, comprised of one or more paired sets of anion and cation exchange resin units 90 and 92, is exhausted. A valve or other unit 100 capable of directing water flow is placed before, or upstream from, the ion exchange resin elements. The water initially flows through the primary resin element comprised of one or more paired sets of anion and cation exchange resin units 90 and 92 until the monitor 98 detects that the resin in either of such anion and cation exchange resin units 90 and 92 is exhausted. The monitor unit 98 sends a signal to unit 100, which triggers a redirection of water flow through the secondary ion exchange resin element comprised of one or more paired sets of anion and cation exchange resin units 94 and 96. The monitor 98 also provides notice that said primary ion exchange resin element requires maintenance service, but the system continues to function while system maintenance service is scheduled.

This parallel configuration may also be accomplished with one or more mixed bed ion exchange resin unit(s) configured as a primary ion exchange resin element, along with one or more mixed bed ion exchange resin unit(s) configured as a secondary ion exchange resin element, so long as exhaustion of the primary ion exchange resin element triggers a redirection of flow to the secondary ion exchange resin element. In any such parallel system one or more check valves (not shown) which will force water to flow in the intended path may be required. Further, a manual or automated method or device which will redirect the flow of water to the primary path following maintenance service involving reassignment or reconfiguration of the secondary ion exchange resin element as the primary ion exchange resin element, along with replacement of the secondary ion exchange resin element with successor fresh or regenerated ion exchange resin unit(s), may be necessary to assure the reliable supply of purified water.

The embodiments of the water purification system described herein are intended to be adaptable to either mixed bed ion exchange resin units or paired sets of anion and cation exchange resin units. The ion exchange resin elements in the system 10 may be changed from mixed bed ion exchange resin units to paired sets of anion and cation exchange resin units or from paired sets of anion and cation exchange resin units to mixed bed ion exchange resin units. When maintenance service is performed on the system 10, the current primary ion exchange resin element is replaced with the current secondary ion exchange resin element and a successor fresh or regenerated secondary ion exchange resin element is added or introduced to the system. During such maintenance service, a different type of ion exchange resin element may be installed as the replacement secondary ion exchange resin element, permitting additional flexibility in the use of the water purification system 10. In describing maintenance service on the ion exchange resin elements, the word current is intended to mean the ion exchange resin elements that have been in use in the water purification system. The word replacement is intended to encompass multiple substitutions and reconfigurations for the ion exchange resin elements in the water purification system, including, but not limited to, removal of the exhausted primary ion exchange resin element, substitution of the secondary ion exchange resin element as the primary ion exchange resin element, and replacement of the secondary ion exchange resin element with virgin, fresh, new, and/or regenerated ion exchange resin units.

The invention is not limited to the embodiments described herein; any configuration of (1) a primary ion exchange resin element that will allow purification of the water, (2) a secondary ion exchange resin element that allows continued uninterrupted purification of the water even though the primary ion exchange resin element is exhausted, and (3) some means of indicating when replacement or regeneration of the primary ion exchange resin element is desired or required, will be suitable. Further, additional mixed bed ion exchange resin units, or paired sets of anion and cation exchange resin units, can be added into the system 10 as needed, so long as the structure of having a secondary resin element and a monitor of some type indicating that the primary resin element is exhausted and therefore the secondary resin element is being used is present in the embodiment. Ion exchange resin elements need not be identical in size or capacity.

I claim:

1. A water purification system designed to provide continuous purified water on demand, comprising:
two ion exchange resin elements; and
a monitor; wherein
one of said two ion exchange resin elements is a primary ion exchange resin element;
one of said two ion exchange resin elements is a secondary ion exchange resin element; and
said monitor provides notification when said primary ion exchange resin element is exhausted and said secondary ion exchange resin element is now purifying water.

2. A water purification system as claimed in claim 1, wherein said primary ion exchange resin element is comprised of at least one mixed bed ion exchange resin unit;
said secondary ion exchange resin element is comprised of at least one mixed bed ion exchange resin unit;
said primary ion exchange resin element is placed in series with and upstream from said secondary ion exchange resin element;
said monitor is placed in series with and downstream from said primary ion exchange resin element; and
said monitor is placed in series with and upstream from said secondary ion exchange resin element.

3. A water purification system as claimed in claim 1, wherein
said primary ion exchange resin element is comprised of at least one paired set of anion and cation exchange resin units;
said secondary ion exchange resin element is comprised of at least one paired set of anion and cation exchange resin units;
said primary ion exchange resin element is placed in series with and upstream from said secondary ion exchange resin element;
said monitor is placed in series with and downstream from said primary ion exchange resin element; and
said monitor is placed in series with and upstream from said secondary ion exchange resin element.

4. A water purification system as claimed in claim 1, wherein
said primary ion exchange resin element is comprised of at least one mixed bed ion exchange resin unit;
said secondary ion exchange resin element is comprised of at least one mixed bed ion exchange resin unit;
said primary ion exchange resin element and said secondary exchange resin element each have one outlet;
said primary ion exchange resin element is placed in parallel with said secondary ion exchange resin element; and
said monitor is placed downstream from said primary ion exchange resin element and upstream from the point where said output of said secondary ion exchange resin element joins said output from said primary ion exchange resin element.

5. A water purification system as claimed in claim 1, wherein
said primary ion exchange resin element is comprised of at least one paired set of anion and cation exchange resin units;
said secondary ion exchange resin element is comprised of at least one paired set of anion and cation exchange resin units;
said primary ion exchange resin element and said secondary exchange resin element each have one outlet;
said primary ion exchange resin element is placed in parallel with said secondary ion exchange resin element; and
said monitor is placed downstream from said primary ion exchange resin element and upstream from the point where said output of said secondary ion exchange resin element joins said output from said primary ion exchange resin element.

6. A water purification system as claimed in claim 1, wherein said secondary ion exchange resin element is comprised of at least one mixed bed ion exchange resin unit and said secondary ion exchange resin element is replaced with at least one paired set of anion and cation exchange resin units.

7. A water purification system as claimed in claim 1, wherein said secondary ion exchange resin element is comprised of at least one paired set of anion and cation exchange resin units and said secondary ion exchange resin element is replaced with at least one mixed bed ion exchange resin unit.

8. A water purification system as claimed in claim 1, further comprising at least one activated carbon element placed in series with the ion exchange resin elements.

9. A water purification system as claimed in claim 1, further comprising two activated carbon elements, wherein
one activated carbon element is a primary activated carbon element;
one activated carbon element is a secondary activated carbon element; and
said primary activated carbon element is placed in series with and upstream from said secondary activated carbon element.

10. A water purification system as claimed in claim 1, further comprising a sanitizing element.

11. A water purification system as claimed in claim 10, wherein said sanitizing element is selected from a group consisting of
an ultraviolet light radiation element; and
an ozone treatment element.

12. A water purification system as claimed in claim 1, further comprising a sterilizing filter element.

13. A water purification system as claimed in claim 12, further comprising a prefilter element, wherein said prefilter element is placed in series with and upstream from said sterilizing filter element.

14. A water purification system as claimed in claim 1, wherein said water purification system is configured in a continuous loop.

15. A water purification system as claimed in claim 14, wherein said loop further comprises:
a pump; and
at least one check valve.

16. A water purification system as claimed in claim 1, wherein additional ion exchange resin elements and monitors are incorporated into said water purification system.

17. A method of purifying water, comprising the steps of:
providing a primary ion exchange resin element; and
a secondary ion exchange resin element;
providing a monitor; and
using said monitor to detect when said primary ion exchange resin element requires maintenance service.

18. A method of purifying water as claimed in claim 17, wherein
said primary ion exchange resin element is replaced with said secondary ion exchange resin element upon maintenance service;
where said secondary ion exchange resin element comprises at least one mixed bed ion exchange resin unit, said secondary ion exchange resin element is replaced with at least one of:
a replacement mixed bed ion exchange resin unit; or
a replacement paired set of an anion exchange resin unit and a cation exchange resin unit.

19. A method of purifying water as claimed in claim 17, wherein
said primary ion exchange resin element is replaced with said secondary ion exchange resin element upon maintenance service;
where said secondary ion exchange resin element comprises at least one paired set of an anion exchange resin unit and a cation exchange resin unit, said secondary ion exchange resin element is replaced with at least one of:
a replacement mixed bed ion exchange resin unit; or
a replacement paired set of an anion exchange resin unit and a cation exchange resin unit.

20. A water purification system designed to provide continuous uninterrupted
purified water on demand, comprising:
two ion exchange resin elements;
at least one monitor element;
at least one activated carbon element;
at least one sanitizing element;
at least one prefilter element;
at least one sterilizing filter element;
at least one pump element;
at least one check valve element; and
at least one outlet element;
wherein
one of said two ion exchange resin elements is a primary ion exchange resin element;
one of said two ion exchange resin elements is a secondary ion exchange resin element; and
said at least one monitor is placed downstream from said primary ion exchange resin element and upstream from said secondary ion exchange resin element and provides notification when said primary ion exchange resin element is exhausted and said secondary ion exchange resin element is now purifying water.
